(19) United States
(12) Patent Application Publication
(10) Pub. No.: US 2026/0046203 A1
(43) Pub. Date: Feb. 12, 2026

(54) NETWORK DEVICE, METHOD FOR DEVICE NETWORKING AND NETWORK OF DEVICES

(71) Applicant: LEDVANCE GmbH, Garching bei München (DE)

(72) Inventors: Wuqiang LIAO, Shenzhen Guangdong (CN); Heng LI, Shenzhen Guangdong (CN)

(21) Appl. No.: 19/284,138

(22) Filed: Jul. 29, 2025

(30) Foreign Application Priority Data
Aug. 6, 2024 (CN) 202411071719.4

(51) Int. Cl. H04L 41/0806; H04W 8/00

(52) U.S. Cl. CPC H04L 41/0806; H04W 8/005

(57) ABSTRACT

A network device is provided. The network device includes an interaction detection module configured to detect a physical interaction event involving a network device and a second network device and provide interaction data related to the physical interaction. The network device further includes a wireless communication module for communicating with another network device, and a control module configured to evaluate the interaction data received from the interaction detection module and configure the network device for network communication based at least in part on the interaction data. In addition, a method for device networking and a network of devices are provided.

### CROSS-REFERENCE TO RELATED APPLICATIONS

This patent application claims the benefit of and priority to Chinese Patent Application No. 202411071719.4, filed on Aug. 6, 2024, which is herein incorporated by reference in its entirety.

### FIELD OF THE DISCLOSURE

The present application generally relates to the technical field of network devices. In particular, the present disclosure relates to a network device, a method for device networking, and a network of devices.

### BACKGROUND

There are known network devices or networked devices and device networks with two or more network devices, such as the Internet of Things (IOT). In order to join the network, it is usually necessary to commission or configure the network devices accordingly.

Commissioning and configuration of network devices may be a time-consuming and tedious process. In addition, this process also requires additional equipment, such as commissioning tools, QR scanners, smart phones or other equipment, which further complicates the setup and increases the risk of errors.

### SUMMARY

Provided is a convenient and user-friendly method for device networking.

According to a first aspect, a network device is provided. Here, the network device is defined as a device for networking. In a non-limiting embodiment, the network device is a smart device, which can communicate with another device having communication capabilities such as to join or form a network of devices. As a non-limiting example, the network is Internet of Things.

Network devices in the context of the present application may include without limiting, light-emitting diode (LED) drivers, buttons, panels, sensors, etc.

The network device includes an interaction detection module configured to detect a physical interaction event involving a network device (hereinafter a first network device) and another network device (hereinafter a second or target network device). The second network device may be provided as a networked device with similar network capabilities as the first network device. The interaction detection module is further configured to provide interaction data related to physical interaction, especially after the physical interaction is detected.

The network device further includes a wireless communication module for communicating with another network device. In addition, the network device may include one or more wired or wireless communication modules. In a non-limiting embodiment, the wireless communication module is a primary communication module or main communication module, for communicating with another device in a network based on one or more communication protocols, such as ZigBee, Bluetooth Low Energy (BLE), Wi-Fi, Digital Addressable Lighting Interface (DALI), 2.4 GHz wireless, Power Line Communication (PLC), and the like. Bluetooth is a registered trademark of Bluetooth Technology Alliance. ZigBee is a registered trademark of ZigBee Alliance. Wi-Fi is a registered trademark of the Wi-Fi Alliance. DALI is a registered trademark of the International Standardization Union for Lighting and Building Automation Networks.

The network device further includes a control module configured to evaluate the interaction data received from the interaction detection module and configure the network device based at least in part on the interaction data.

Configuring the network device may include configuring the network device to join an existing device network or creating a new network of devices. Configuring may also include commissioning a network device to join the network.

The interaction detection module may be configured to detect a physical interaction between network devices. In some embodiments, the interaction detection module is configured to identify a detected interaction and forward the interaction data and/or information about identified interaction to the control module. In a non-limiting embodiment, the interaction detection module may be configured to forward the interaction data to the control module in response to the identification of the interaction between the network device and another network device.

The control module may be configured to manage the commissioning and configuration status of the network device. Similarly, the second or target network device may include an interaction detection module, a communication module and a control module. The control module of the second network device may be configured to manage the commissioning and configuration status of the second network device.

The control module of the first network device and the second network device may be further configured to exchange any network-related information needed to start and complete the commissioning and/or configuration of the network device. Therefore, the network device may obtain mutual parameters to complete further actions of the commissioning the network device.

Therefore, network devices may be paired and configured so as to build networks with each other and/or with other network devices.

Commissioning or configuration of the devices can be triggered only by physical interaction between two devices without additional devices or tools. This cases the set-up of a device network for users.

In addition, by coupling different devices one by one, multiple network devices can be commissioned to form a multi-device network.

The interaction detection module may be configured to detect physical contact or direct physical interaction between the network device and the second network device. Therefore, simply physical contact between two devices can start the connection, configuration and commission process. In a non-limiting embodiment, the contact that can be detected by the interaction detection module may include a tap between the devices, a physical contact between the devices, a rubbing motion between the devices, and/or the like.

The interaction detection module may be configured to detect a tapping between the network devices, a physical contact between the network devices maintained for a predetermined minimum time (for example, three seconds), and/or a rubbing motion between the network devices. In a non-limiting embodiment, the interaction detection module may be configured to detect a slight or even the slightest tap and/or rubbing motion between the network devices without causing any significant risk of damage to the network device.

The interaction detection module may include at least one interaction detection system having at least one interaction detection sensor. The interaction detection sensor may include one or more tapping, touching and/or contacting sensors. In a non-limiting embodiment, the interaction detection sensor includes one or more of a magnetic sensor, a tapping/touching detectors, an accelerometer and/or a gyroscope.

The control module may be configured to instruct the wireless communication module to broadcast interaction event information, discover the presence of a second (target) device, and initiate a handshake with the second device. The handshake between the first network device and the second or target network device ensures a smooth and reliable pairing between the first network device and the second network device.

The control module may be configured to discover the presence of an existing network of devices, and to create a new network if no network is detected. In particular, in the absence of an existing device network, the first network device and the second network device may first form a network of the two devices, which may be joined by other devices and thus the network is expanded.

The control module may be configured to send a message to the second device, to notify the second device to join a new network or a newly created network. In a non-limiting embodiment, once the handshake is successful, the control module may instruct the communication module to send network information of the network device to the target device to join the new network.

In some embodiments, the network device includes a power module for supplying power to the interaction detection module, the control module and at least one communication module. Because of the presence of power module, in case that the network device is provided as an AC equipment powered by power grid, even if the network device is disconnected from the power grid, the device can be powered and may be configured through physical interaction.

According to a second aspect, a method for device networking is provided. The method includes providing a first network device and a second network device. The first network device and the second network device may be configured in particular according to the first aspect. In a non-limiting embodiment, each of the first and second network devices may include an interaction detection module configured to detect a physical interaction event involving the first network device and the second network device. The first and second network devices may further include at least one wireless communication module and a control module as described above.

The method further includes detecting a physical interaction event. Physical interaction can be detected in particular by the interaction detection module of the first network device and/or the second network device.

The method further includes sending interaction data related to the physical interaction to a control module of the first network device and/or the second network device in particular. In a non-limiting embodiment, once the physical interaction is detected, the interaction detection module of the first network device and/or the second network device may send the interaction data to the corresponding control module.

The method further includes evaluating the interaction data and configuring the first network device and/or the second network device based at least in part on the interaction data. The evaluation of the interactive data may be performed by the control module of the first network device and/or the second network device, respectively.

Configuring the first and/or second network devices may include configuring the first and/or second network devices to join an existing device network or to create a new device network. Configuring may further include commissioning the first and/or second network devices to join the device network.

According to this method, the commission or configuration of the devices can be triggered simply by the physical interaction between two devices without additional devices or tools. This cases the task of users to set up or expand the network of devices.

The method may include initiating a handshake between the first network device and the second network device when physical interaction between the first network device and the second network device is detected. The handshake between the first network device and the second network device ensures a smooth and reliable pairing between the first network device and the second network device.

According to a third aspect, a network of devices is provided. The network includes a plurality of network devices, in particular at least two network devices. The device network includes at least one network device according to the first aspect. Since the presence of the network device according to the first aspect, it is possible to configure and commission another device simply by a physically interaction/contact between the network devices. Thereby, the network may be easily expanded.

In the following description, details are provided to illustrate the embodiments of this specification. However, it will be apparent to those skilled in the art that the embodiments may be implemented without these details.

Some parts of the embodiments share similar parts. These similar parts may have the same name or similar reference numbers. Where appropriate, the description of one part is applicable to another similar part by reference, thus reducing the repetition of the descriptions without limiting the present disclosure.

### BRIEF DESCRIPTION OF THE DRAWINGS

FIG. 1 shows a schematic diagram of a network device according to one embodiment,

FIG. 2 shows a schematic diagram of two network devices according to one embodiment,

FIG. 3 shows a schematic diagram of a network device according to one embodiment,

FIG. 4 shows a schematic diagram of a network device according to another embodiment,

FIG. 5 shows an example of an implementation of a method for device networking according to one embodiment,

FIG. 6 shows an of an implementation of a method for device networking according to another embodiment, and

FIG. 7 shows a flowchart of a method for device networking according to one embodiment.

### DETAILED DESCRIPTION

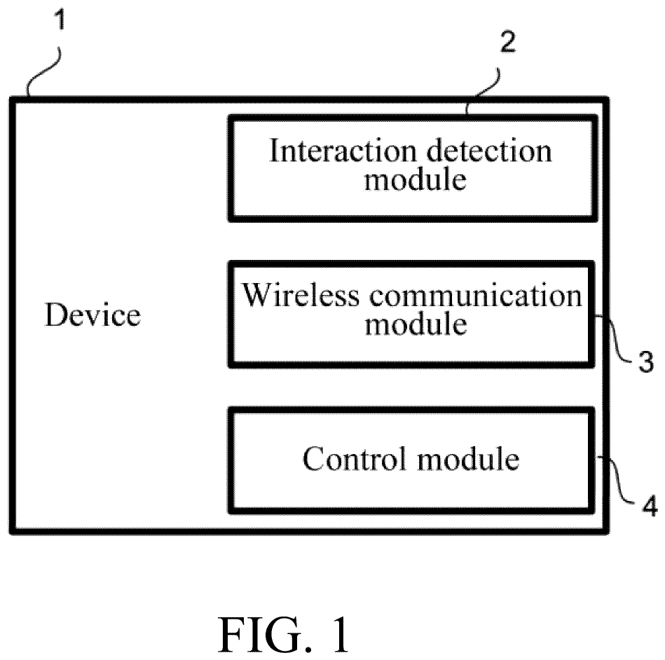

FIG. 1 shows a schematic diagram of a network device 1 according to one embodiment. Network device 1 is a configurable networked device which, when configured and/or commissioned accordingly, joins a network of devices or builds a new network.

In a non-limiting embodiment, network device 1 includes an interaction detection module 2, a wireless communication module 3, and a control module 4.

Interaction detection module 2 is configured to detect a physical interaction involving network device 1 and another network device.

Interaction detection module 2 is further configured to provide interaction data related to the physical interaction to control module 4.

Wireless communication module 3 is configured to communicate with other network devices. According to an embodiment, network device 1 may include more than one communication module, especially a primary communication module or a main communication module, for example, for communication based on one or more communication protocols, such as Near Field Communication (NFC), ZigBee, Bluetooth Low Energy (BLE), Wi-Fi, Digital Addressable Lighting Interface (DALI), radio operating around 2.4 GHz, Power Line Communication (PLC), and the like.

In a non-limiting embodiment, wireless communication module 3 may be configured for device discovery and information exchange temporarily, especially only or exceptionally, when an interaction event occurs, until the primary communication module takes over communication with other devices in the network.

In a non-limiting example, wireless communication module 3 may be an independent communication module separated from the primary communication module or the main communication module, such as a built-in NFC reader 8 and an NFC chip 9.

In some embodiments, the functions of wireless communication module 3, especially the temporary information exchange, are realized by the primary communication module (e.g., a Bluetooth module or a ZigBee module) of the IoT device.

Wireless communication module 3 of network device 1 may be especially configured to broadcast events and network information and exchange network and other necessary information with corresponding target devices or interaction peers.

Control module 4 may include a processor and a storage unit for storing data and machine-readable instructions executable by the processor. Control module 4 may further include an interface for communicating (especially for exchanging data) with interaction detection module 2 and wireless communication module 3. In a non-limiting embodiment, control module 4 may be configured by writing corresponding data and machine-readable instructions into the storage unit. For simplicity, the interface, processor, and storage unit of control module 4 are not shown in FIG. 1.

Control module 4 is configured to receive interaction data from interaction detection module 2, evaluate the data, and configure network device 1 based at least in part on the interaction data.

Control module 4 may be further configured to perform further steps of a method according to one of various embodiments related to the corresponding stored data and/or machine-readable instructions in a storage unit of control module 4.

In particular, control module 4 may be configured to instruct wireless communication module 3 to broadcast events and network information and exchange network and other necessary information with corresponding target devices or interaction peers.

In some embodiments, confirmed by wireless communication module 3, the device information and network information of the interaction device are transferred to control module 4, thereby starting the network configuration processing logic of the network device 1.

Therefore, the primary network module or the main network module of network device 1 can be commissioned. In a non-limiting embodiment, wireless communication module 3 may only be used for handshake and information sharing when an interaction event is detected. This information may be used to commission the main network module of network device 1 subsequently.

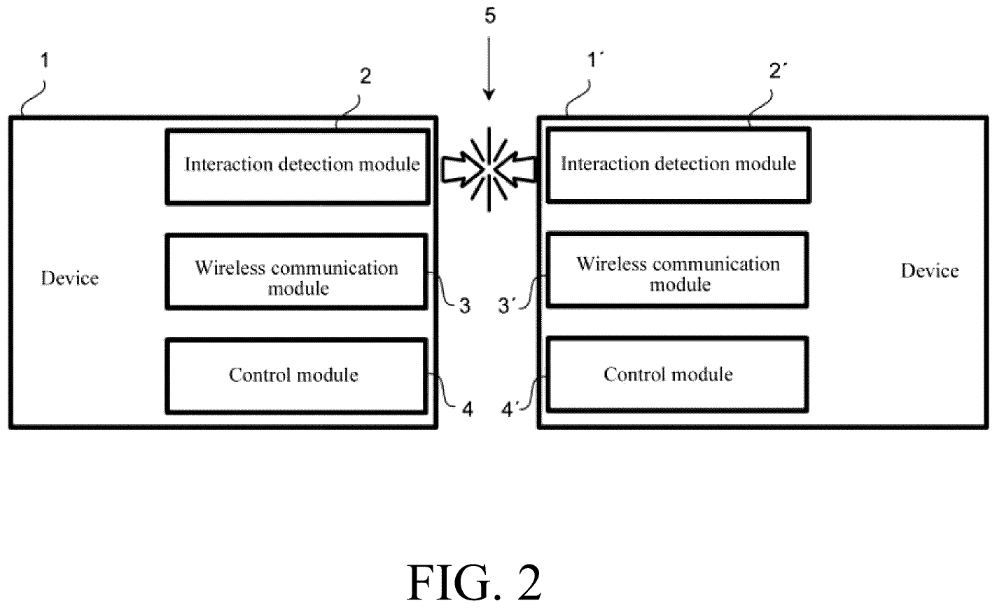

FIG. 2 shows a schematic diagram of two network devices 1, 1′ according to one embodiment. In particular, FIG. 2 shows a first network device 1 and a second network device 1′. In this embodiment, both network devices 1, 1′ are similarly provided as IoT devices, and when configured and/or commissioned accordingly, they can join a network of devices or build a new network.

In a non-limiting embodiment, each of network devices 1, 1′ includes an interaction detection module 2, 2′, a wireless communication module 3, 3′, and a control module 4, 4′, which are described with respect to FIG. 1 previously.

Interaction detection modules 2 and 2′ are configured to detect physical interactions involving first network device 1 and second device 1′, respectively. Physical interaction 5 is depicted schematically in FIG. 2.

Interaction detection modules 2 and 2′ are further configured to provide interaction data related to physical interaction 5 to control modules 4 and 4′, respectively.

Wireless communication modules 3, 3′ of first network device 1 and/or second network device l′ may be especially configured to broadcast events and network information and exchange network and other basic information with corresponding target devices or interaction peers.

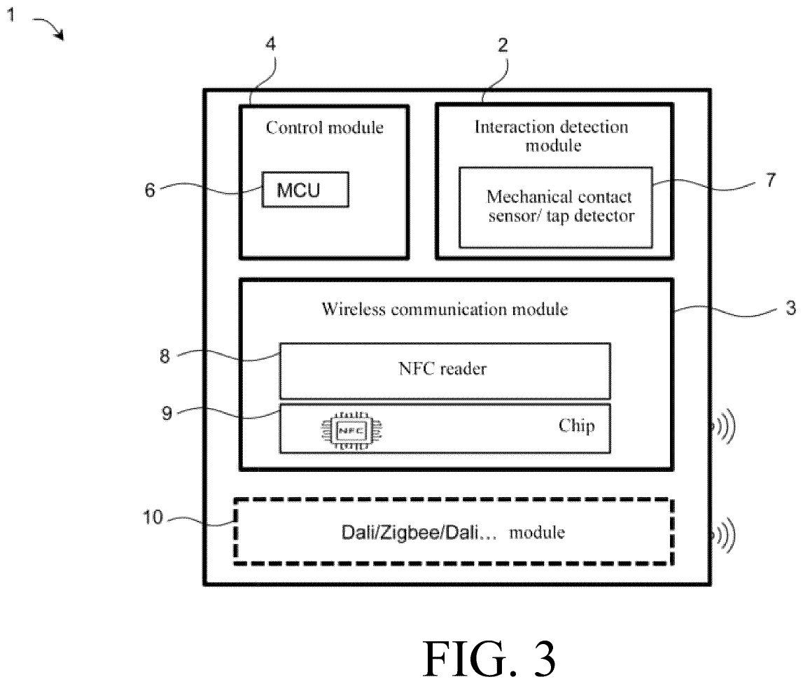

FIG. 3 shows a schematic diagram of a network device 1 according to one embodiment. The embodiment of FIG. 3 generally corresponds to the embodiment of FIG. 1, but with greater details that control module 4 includes a microcontroller unit (MCU) 6 and interaction detection module 2 includes a mechanical contact sensor or tap-detection sensor 7.

Wireless communication module 3 is implemented as an independent wireless communication module, especially implemented as an NFC module including an NFC reader 8 and an NFC chip 9, for exchanging network configuration information and handshake.

Network device 1, according to FIG. 3, further includes a primary communication module 10. Primary communication module 10 can be configured to communicate based on standard communication protocols (such as DALI, ZigBee, etc.).

Therefore, network device 1, according to FIG. 3, can communicate with another device through wireless communication module 3 and primary communication module 10.

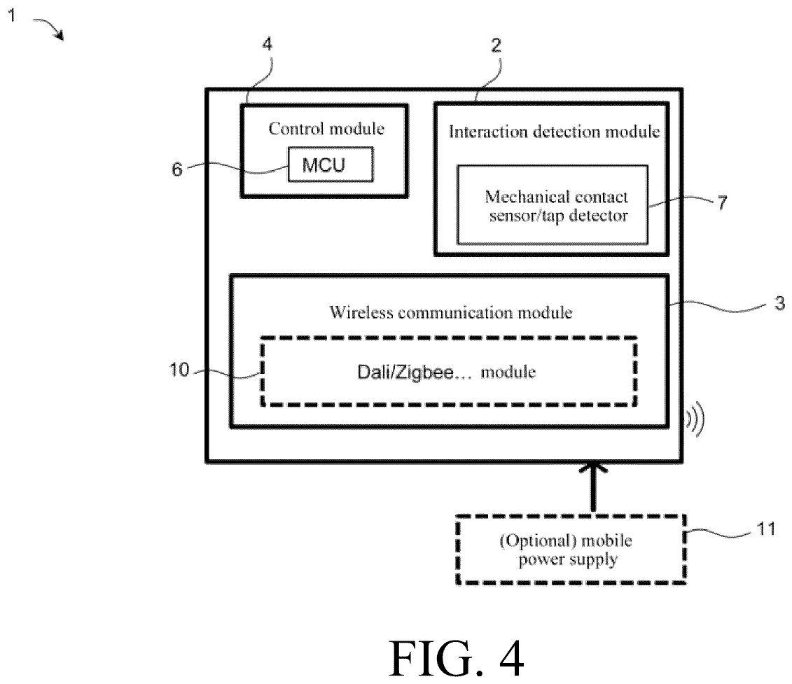

FIG. 4 shows a schematic diagram of a network device 1 according to another embodiment. The embodiment of FIG. 4 generally corresponds to the embodiment of FIG. 3, but with greater details that wireless communication module 3 is implemented as primary communication module 10, which is responsible for the configuration of network device 1 and the operation of the device network once network device 1 is configured and/or commissioned for the device network.

Network device 1, according to the embodiment of FIG. 4, further includes an auxiliary power module 11, which can be used as a secondary power when the primary power supply is turned off.

In a non-limiting embodiment, for a network device 1 that needs to be installed and connected to the power grid, auxiliary power module 11 can be used for interaction configuration and/or commissioning before installation. Auxiliary power module 11 can be an internal battery or an external portable power supply.

In some embodiments, auxiliary power module 11 is configured to supply power to at least interaction detection module 2, control module 4, and wireless communication module 3 before installation.

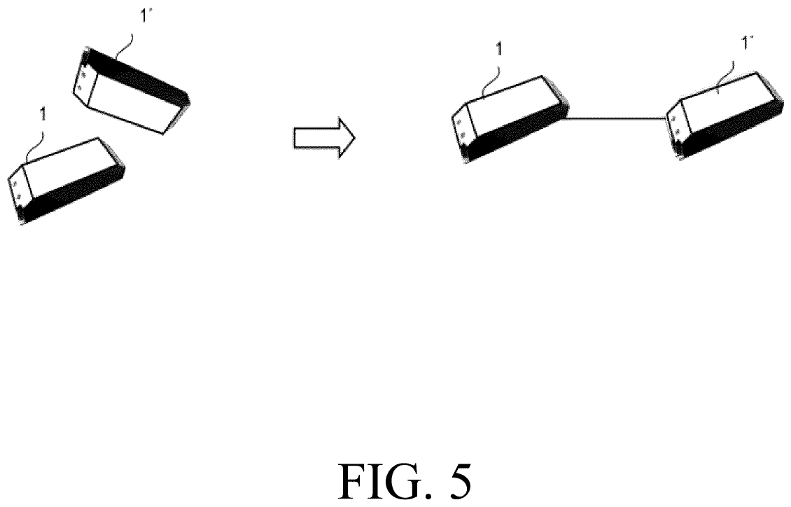

FIG. 5 shows an example of an implementation of a method for a device network according to one embodiment. The example of FIG. 5 relates to two network devices 1, 1′ configured according to the first aspect—in particular, according to any of the embodiments shown in FIGS. 1 to 4.

The left side of FIG. 5 shows network devices 1 and 1′ in an initial state, in which no network connection is established between network devices 1 and 1′. The right side of FIG. 5 shows network devices 1 and 1′ in a final state, in which a network connection is established between network devices 1 and 1′.

Due to the configuration of network devices 1 and 1′, according to this embodiment, the transition from the initial state to the final state can be established simply by a tap between the two network devices 1 and 1′. The transition is indicated by an arrow in the middle.

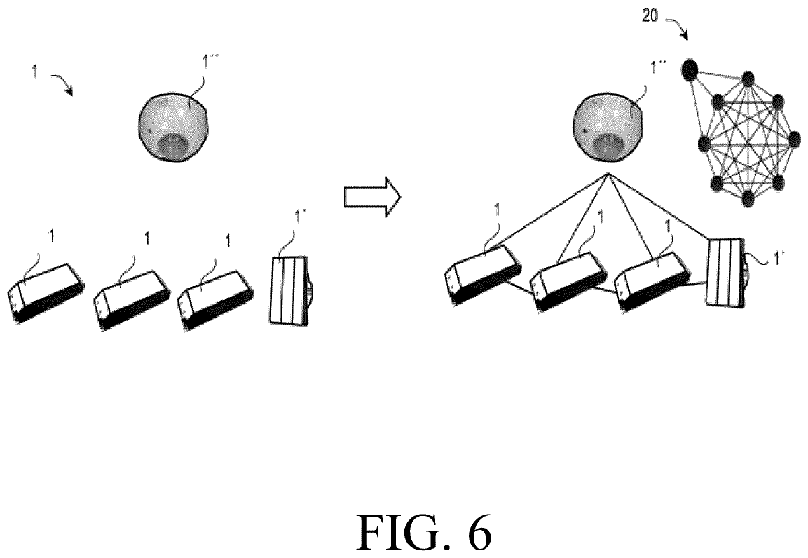

FIG. 6 shows an example of an implementation of a method for a device network according to another embodiment. The example shown in FIG. 6 relates to three different types of network devices 1, 1′, 1″—in particular, three driver modules 1, a switch 1′, and a presence sensor 1″. All these devices 1, 1′, 1″ are configured as smart devices with networking function according to the first aspect described above.

The left side of FIG. 6 corresponds to an initial state, in which network devices 1, 1′, 1″ are not connected with one another; that is, no network connection is established between any two of the network devices 1, 1′, and 1″. The right side of FIG. 6 shows network devices 1, 1′, 1″ in a final state, in which a network connection is established among the network devices 1, 1′, and 1″.

Due to the configuration of network devices 1, 1′, 1″ according to this embodiment, the transition from the initial state to the final state can be established only by a tap between any two of the network devices 1, 1′, 1″, which transition is indicated by an arrow in the middle. Therefore, a mesh network 20 of devices 1, 1′, 1″ can be created, as schematically shown in the upper right corner of FIG. 6. By applying this principle, a device network with any size and any topology can be created.

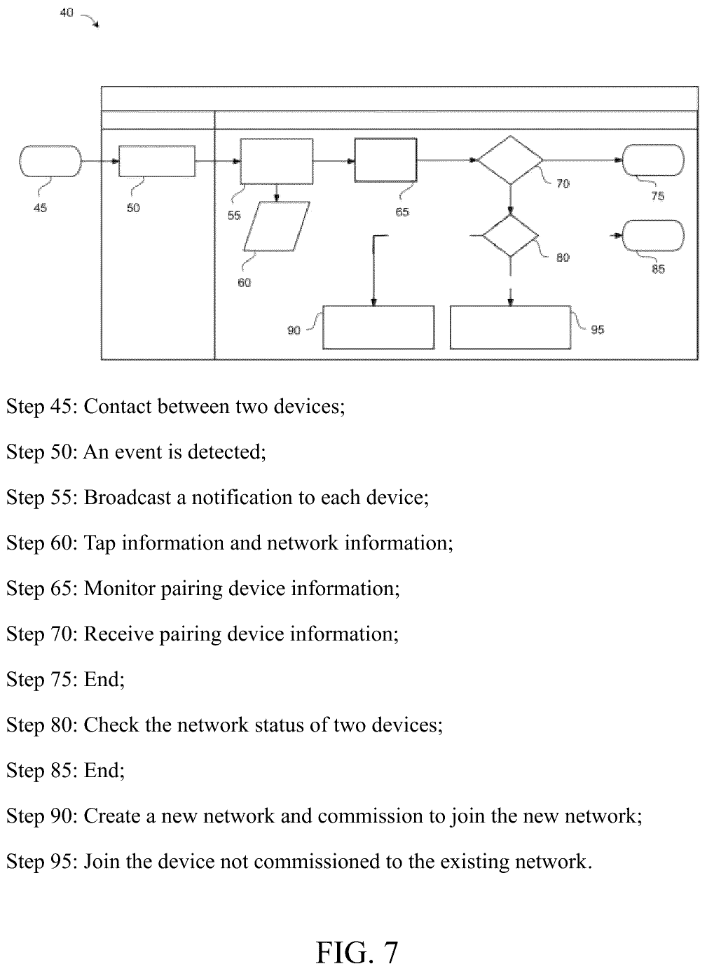

FIG. 7 shows a flowchart of a method 40 for device networking according to one embodiment. Method 40 may be performed by at least two network devices to commission those devices to join a network of devices or to create a new network of devices. In a non-limiting embodiment, method 40 may be applied to further devices to expand the network created.

According to FIG. 7, method 40 can be initiated by physical interaction between a first network device and a second network device in step 45. Step 45 or the previous step further may include providing two network devices equipped with the modules of the network device(s) described in any one of the embodiments above.

In step 50, a physical interaction event involving a first network device and a second network device is detected. The detection of physical interaction can be performed, in particular, by interaction detection module 2 of the corresponding device. Specifically, the physical interaction can be detected by interaction detection module 2 of each of the two network devices.

Step 50 also may include providing interaction data, that is, data related to the detected physical interaction. In a non-limiting embodiment, the interaction data can be sent from interaction detection module 2 to control module 4 of the corresponding network device.

After receiving the interaction data from interaction detection module 2, control module 4 may take over the control of all the subsequent steps shown in FIG. 7. In a non-limiting embodiment, control module 4 may evaluate the interaction data based at least in part on the interaction data received from interaction detection module 2 and take over the coordination of all subsequent steps.

In the embodiment of FIG. 7, method 40 further includes broadcasting a notification from one or each of the network devices in step 55, which notification can be received by the corresponding interaction partner device. In a non-limiting embodiment, the broadcast can be performed by wireless communication module 3 of the device.

In a non-limiting embodiment, wireless communication module 3 may be instructed by the respective control module 4 to broadcast the notification, so that the interactive peer device, especially wireless communication module 3 of the peer device, can receive the notification.

In step 60, tap information and network information are broadcast, especially through wireless communication module 3 of the network device. Method 40 may proceed to further step 65 in FIG. 7, which involves monitoring for pairing device information (see step 65 in FIG. 7).

In step 70, pairing device information may be received. If the pairing device information is not received in step 70, method 40 proceeds to step 75, and terminates. The pairing device information particularly may include network-related information or information related to networking. In a non-limiting embodiment, the pairing device information may include information about the current status of network devices.

If the pairing device information is received in step 70, method 40 proceeds to step 80 shown in FIG. 7, in which a check for the network status of the two devices is performed.

If the network status check in step 80 shows that both network devices have been commissioned or joined the network, method 40 proceeds to step 85 and terminates. In some embodiments, if both devices are already joined the network, adjustments are made as needed according to the decision options.

If the network status check in step 80 shows that no network device has been commissioned and joined any existing network, a new network can be created, and two network devices can be commissioned and join the newly created network in step 90. In a non-limiting embodiment, control module 4 (especially control module 4 of the first and/or second device) can actively create a new network. Then, control module 4 sends a message to the two devices to notify them to join the newly created network.

In a non-limiting example, after detecting the interaction, the two devices can start commissioning and join the same network, such as a network operating ZigBee, BLE, DALI, etc.

The network device or control module 4 of the network device can be configured such that the network device can be commissioned and join the same group of devices in the network.

In some embodiments, a network device may be configured to disconnect from the network or perform additional configuration steps after detecting a physical interaction event.

If the network status check in step 80 indicates that only one of the two network devices is commissioned and joined the existing network, method 40 may proceed to step 95 in which the non-commissioned network device joins the existing network.

In some embodiments, a network device may create and/or join a network in response to a detection of an event and a reception of interaction data. In some other embodiments, event information is stored and processed first, and then network commissioning and pairing are performed subsequently (for example, after power-on or at the time of a universal additional event).

Due to the novel method 40 for forming a device network described above, the pairing process is particularly simple, because gently bumping/hitting or sticking two devices together is enough to start the configuration and/or commissioning process.

In addition, this method 40 does not need any additional devices, such as NFC readers or any mobile applications. Therefore, this method 40 allows each device to pair with any other device using exactly the same mechanism without a primary node.

In addition, because the process is based on the principle of “what you see is what you get,” it is particularly accurate and error-free. Specifically, the pairing process involves intuitive selection of physical devices, thus making the process particularly accurate and reliable.

In addition, this method 40 has strong scalability. Users can extend the functions of the system through user-defined tapping methods, especially for group control. These devices also provide convenience to support other network configuration processes (such as grouping, scenarios, and schedules), making their operation user-friendly and efficient.

Therefore, it is possible to quickly and easily expand the network device group by pairing and commissioning other network devices one by one. In addition, method 40 can be operated off-line, which means that it can be carried out without Internet access, thus no Internet connection is required.

Although at least one exemplary embodiment has been introduced in the foregoing detailed description, it should be understood that there are numerous variations. It should also be understood that one or more exemplary embodiments are merely examples and are not intended to limit the scope, applicability or configuration of the present disclosure in any way. Rather, the foregoing detailed description will provide those skilled in the art with a convenient road map for implementing one or more exemplary embodiments.

### LIST OF REFERENCE NUMBERS

1, 1′, 1″ network device;
2, 2′ interaction detection module;
3, 3′ wireless communication module;
4, 4′ control module;
5 physical interaction;
6 microcontroller unit (MCU);
7 mechanical contact or tap detection sensor,
8 NFC reader;
9 NFC chip;
10 primary communication module;
11 auxiliary power module;
20 mesh network;
40 method;
45 step of a method;
50 step of a method;
55 step of a method;
60 step of a method;
65 step of a method;
70 step of a method;
75 step of a method;
80 step of a method;
85 step of a method;
90 step of a method;
95 step of a method.

What is claimed is:

1. A network device comprising:
an interaction detection module configured to:
detect a physical interaction event involving the network device and a second network device; and
provide interaction data related to the physical interaction event;
a wireless communication module configured to communicate with another network device; and
a control module configured to:
evaluate the interaction data received from the interaction detection module; and
based at least in part on the interaction data, configure the network device for network communication.

2. The network device according to claim 1, wherein the interaction detection module is further configured to detect physical contact between the network device and the second network device.

3. The network device according to claim 2, wherein the physical contact comprises at least one of:
a tapping between the network device and the second network device;
physical contact of the network device and the second network device maintained for a predefined minimum time; and
a rubbing motion between the network device and the second network device.

4. The network device according to claim 1, wherein the interaction detection module comprises at least one interaction detection system comprising at least one interaction detection sensor.

5. The network device according to claim 1, wherein the control module is further configured to:
instruct the wireless communication module to broadcast physical interaction event information;
discover a presence of the second network device; and
initiate a handshake with the second network device.

6. The network device according to claim 5, wherein the control module is further configured to:
discover a presence of an existing device network and, if no existing device network is discovered, create a new device network.

7. The network device according to claim 6, wherein the control module is further configured to:
send a message to the second network device to notify the second network device to join the new device network.

8. A device network comprising at least one network device according to claim 1.

9. A method for device networking, the method comprising:
detecting a physical interaction event involving a first network device and a second network device;
providing interaction data related to the physical interaction event;
processing the interaction data; and
based at least in part on the interaction data, configuring at least one of the first network device and the second network device.

10. The method according to claim 9, further comprising:
initiating a handshake between the first network device and the second network device in response to the physical interaction detected between the first network device and the second network device.
